(19) United States
(12) Patent Application Publication
(10) Pub. No.: US 2004/0120227 A1
(43) Pub. Date: Jun. 24, 2004

(54) Method for controlling playback operation in optical disc apparatus

(76) Inventors: Gyoo Min Han, Incheon-si (KR); Hwan Kim, Suwon-si (KR); Ki Young Lee, Osan-si (KR)

Correspondence Address: FLESHNER & KIM, LLP, P.O. BOX 221200, CHANTILLY, VA, 20153, US

(21) Appl. No.: 10/652,564

(22) Filed: Sep. 2, 2003

(30) Foreign Application Priority Data
Sep. 2, 2002 (KR) 10-2002-0052549
Oct. 14, 2002 (KR) 10-2002-0062325

(51) Int. Cl. G11B 7/085

(52) U.S. Cl. 369/30.25; 707/104.1; 386/126

(57) ABSTRACT

Disclosed is a method for controlling a playback operation in an optical disc apparatus. According to a first embodiment of the invention, an optical disc apparatus has a database in which grades of a plurality of words is stored. The apparatus performs a counting operation to determine when the number of words read from the disk that exceed a predetermined word-grade exceeds a predetermined number. In this way the apparatus determines a viewer-grade of the disc according to the counted number. The apparatus then prevents the optical disc from being played when the viewer-grade of the disk is not appropriate, thereby preventing adolescents or children from being freely exposed to harmful programs. In another embodiment of the invention, an optical disc apparatus classifies words contained in subtitle/caption data read from an optical disc into groups on the basis of a difficulty grade of words. The apparatus then variably determines the number of playback times or a playback sequence for each word, and selectively and repeatedly reproduces individual words of the subtitle/caption data. This allows a user to gradually and repeatedly check words contained in one sentence on the basis of the difficulty grades, which results in greater convenience for the user to learn a foreign language.

### BACKGROUND OF THE INVENTION

1. Field of the Invention

The present invention relates to an optical disc apparatus for reproducing data recorded on an optical disc such as a Digital Versatile Disc (DVD).

2. Background of the Related Art

Typically, an optical disc apparatus (also called an optical disc player) has been adapted to reproduce data recorded on an optical disc such as a DVD disc or a high density DVD (HD-DVD). With the increasing development of data compression technologies for compressing and transferring video/audio data, the performance of the optical disc apparatus has become higher than before.

A disc for use in the optical disc apparatus records various kinds of data, for example, subtitle data written in many languages, caption data or audio language data, such that a user selects his or her desired data among the plurality of data and plays the selected data.

The disc may also contain viewer-grade information, indicative of a proper viewer group, for example, adults, adolescents or children. With this type of information, a user can view his or her desired program (or data) when a prescribed viewer-grade information stored in the optical disc apparatus is identical with the viewer-grade information stored in the disc. This system restrains adolescents or children from viewing adult programs. The user may change current viewer-grade information of the optical disc apparatus to another one by entering a prescribed key command such as a password to the optical disc apparatus.

However, the aforementioned conventional optical disc apparatus has a disadvantage in that the user must visually check whether viewer-grade information of his or her selected disc to be played is identical with that of his or her own optical disc apparatus. Further, the viewer must manually change current view-grade information to another one whenever he or she wants to adapt the optical disc apparatus to play the disc.

Even when a program's viewer-grade information preset in the optical disc apparatus is identical with that of the user-selected disc, harmful subtitle or caption data partially inserted into the program may be unavoidably shown to adolescents or children when the optical disc apparatus plays the program, such that a disc playback function cannot be restricted by such viewer-grade information.

In fact, many countries other than the United States have not recorded viewer-grade information on their manufactured discs. Particularly, most fraudulently duplicated discs have no viewer-grade information, such that almost all of them could play unhealthy information harmful to adolescents or children.

An optical disc for recording/storing a large amount of video and audio data, for example, a DVD disc, often contains subtitle or caption data therein. When the DVD disc is inserted into an optical disc apparatus such as a DVD player, the optical disc apparatus first reads navigation data recorded on a lead-in area of the DVD disc, stores it in a memory, and then performs a common data playback function to read/reproduce the video and audio data recorded on a data area of the DVD disc upon receiving a user's request signal.

Thereafter, the optical disc apparatus reads subtitle/caption data recorded on the DVD disc and performs a subtitle/caption playback function to allow the subtitle/caption data to be overlapped with the video data or to display only the subtitle/caption data. The subtitle/caption data may be selected and reproduced as specific data for only one language selected from among many languages, and may also be repeatedly reproduced by user's desired playback times.

Therefore, the user of the optical disc apparatus can repeatedly view subtitle/caption data written in his or her desired language while viewing high-quality video data reproduced from the DVD disc. As a result, the optical disc apparatus such as a DVD player has become increasingly popular as an electronic means for learning foreign languages.

Such a conventional optical disc apparatus can repeatedly reproduce any subtitle/caption data written in a user-selected language by the prescribed number of times in a subtitle/caption playback mode. But it collectively reproduces many words contained in the same sentence at a time without activating a variety of subtitle/caption display functions such as a caption function for selectively displaying either a word of a relatively low difficulty or another word of a relatively high difficulty. This can result in greater inconvenience for the user who wishes to learn a foreign language.

### SUMMARY OF THE INVENTION

An object of the invention is to solve at least the above problems and/or disadvantages and to provide at least the advantages described hereinafter.

Therefore, the present invention has been made in view of the above problems, and it is an object of the present invention to provide a method for controlling a playback function of an optical disc apparatus that takes viewer-grade information into account when playing subtitle/caption data read from an optical disc, the subtitle/caption data can be played on a display screen on the basis of viewer-grades for a variety of words stored in a prescribed database. A system and method embodying the invention prevents the optical disc from being played by the optical disc apparatus according to the determined viewer-grade.

It is another object of the present invention to provide a method for controlling a playback function of an optical disc apparatus, which classifies a plurality of words contained in subtitle/caption data read from an optical disc such as a DVD disc into a plurality of groups on the basis of some prescribed grades of words. The method may also variably determine the number of playback times or playback sequence of each word, and selectively and repeatedly reproduces individual words of the subtitle/caption data.

In accordance with one aspect of the present invention, the above and other objects can be accomplished by the provision of a method for controlling a playback function of an optical disc apparatus, having a database in which a grade of each word is stored. The method may include the steps of: a) setting a viewer-grade of an optical disc to be played by the optical disc apparatus; b) comparing a character data reproduced from the optical disc with words corresponding to the prescribed grade among grades of words stored in the database, according to the set viewer-grade; c) performing a counting operation whenever the character data belongs to words corresponding to the prescribed grade, and generating a counted number; and d) determining a viewer-grade of the disc according to the count.

In accordance with another aspect of the present invention, there is provided a method for controlling a playback function of an optical disc apparatus, having a database in which a grade of each word is stored. The method includes the steps of: a) setting a desired grade for words capable of being reproduced from an optical disc; b) comparing a character data reproduced from the optical disc with words having a grade higher than the set desired grade among grades of words stored in the database; c) performing a counting operation whenever the character data belongs to words having a grade higher than the set desired grade, and generating a counted number; and d) stopping a playback function of the disc when the counted number is higher than a predetermined number.

In accordance with yet another aspect of the present invention, there is provided a method for controlling a playback function of an optical disk apparatus, including the steps of: a) reading caption data of an optical disc, and determining grades of individual words contained in one sentence on the basis of prescribed word grade information; and b) displaying caption data of a sentence composed of many words wherein more than one word is displayed in the form of a blank space according to the determined grades of words.

In accordance with yet another aspect of the present invention, there is provided a method for controlling a playback function of an optical disk apparatus, including the steps of: a) if a step-by-step repeated playback function for caption data is requested while playing an optical disc, searching for and determining a word grade of the requested caption data read from the disc; b) determining the number of repeating times and playback sequence of the caption data according to the determined word grade; and c) repeatedly displaying the caption data on a screen according to the determined word grade.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, and wherein:

FIG. 1 is a block diagram of an optical apparatus adapted to a playback control method in accordance with a preferred embodiment of the present invention;

FIG. 2 is a flow chart illustrating a playback control method for the optical disc apparatus shown in FIG. 1 in accordance with a preferred embodiment of the present invention;

FIG. 3 is a conceptual diagram illustrating a procedure for counting any foul language words for a predetermined unit time in accordance with a preferred embodiment of the present invention;

FIG. 4 is a conceptual diagram illustrating a procedure for stopping a disc playback operation on the basis of the number of foul language words counted for a predetermined unit-time, or resuming the disc playback operation upon receiving a normal release key command in accordance with a preferred embodiment of the present invention;

FIG. 5 is a conceptual diagram illustrating a procedure for stopping a disc playback operation on the basis of the number of all foul language words detected in a playback mode in accordance with a preferred embodiment of the present invention;

FIG. 6 is a block diagram of an optical disk apparatus adapted to a playback control method in accordance with another preferred embodiment of the present invention;

FIG. 7 is a view illustrating a database containing many grades of words classified into groups in accordance with another preferred embodiment of the present invention;

FIG. 8 is a flow chart illustrating a playback control method for the optical disc apparatus shown in FIG. 7 in accordance with another preferred embodiment of the present invention; and

FIG. 9 is a view illustrating the appearance of subtitle/caption data repeatedly reproduced by the playback control method shown in FIG. 8.

### DETAILED DESCRIPTION OF PREFERRED EMBODIMENTS

Now, preferred embodiments of the present invention will be described in detail with reference to the drawings. In the drawings, the same or similar elements are denoted by the same reference numerals, even though they are depicted in different drawings. In the following description, a detailed description of known functions and configurations incorporated herein will be omitted when it may make the subject matter of the present invention rather unclear.

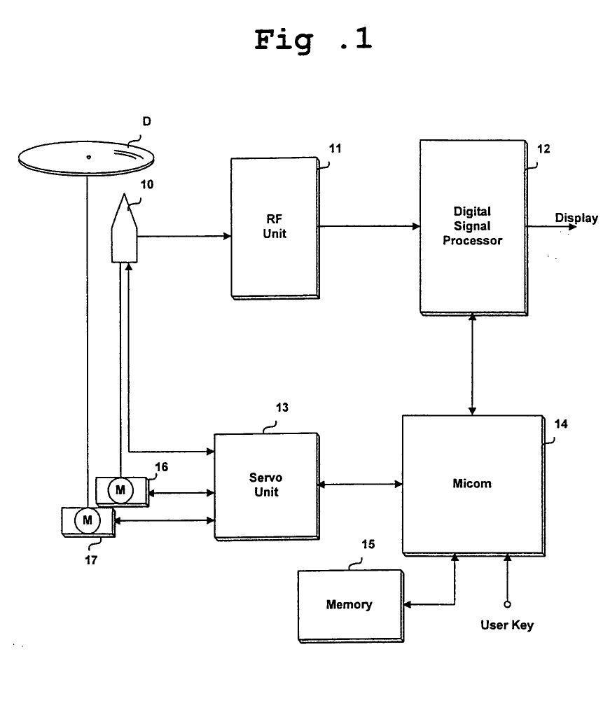

A playback control method for an optical apparatus according to a first preferred embodiment of the present invention will hereinafter be described with reference to FIGS. 1 to 5.

FIG. 1 is a block diagram of an optical disc apparatus adapted to a playback control method in accordance with the first preferred embodiment of the present invention. Referring to FIG. 1, the optical disc apparatus includes an optical pick-up unit 10 for reproducing data recorded on an optical disk D such as a DVD disc. The apparatus includes an RF (Radio Frequency) unit 11 for amplifying data reproduced by the optical pick-up unit 10 or detecting data read from the disc D. A digital signal processor 12 performs signaling with output data of the RF unit 11. The resultant data is output to a prescribed display. A microcomputer 14 controls a data conversion function of the digital signal processor 12. The microcomputer 14 also determines whether subtitle/caption data read from the disc D contains words (foul language words, also called unhealthy words) having grades higher than a prescribed word-grade. The microcomputer 14 makes this determination based on word-grade information recorded on the disc D. The microcomputer 14 may prevent the disc D from being played if it is determined that its subtitle/caption data contains foul language words.

The optical disc apparatus further includes a memory 15 for either storing a variety of control data required for the microcomputer 14, or for storing word-grade information entered by a user. A servo unit 13 controls a sled motor 16 adapted to move the optical pick-up unit 10, and a spindle motor 17 adapted to rotate the disc D upon receiving a control signal of the microcomputer 14. The servo unit 13 thus controls a tracking or focusing function of the optical pick-up unit 10.

The aforementioned optical disc apparatus previously stores various kinds of word-grade information in a prescribed database, determines whether subtitle or caption data currently reproduced from the disc D contains words (foul language words) having grades higher than a prescribed word-grade on the basis of a word-grade information stored in the database, and decides whether to keep playing the disc according the determination.

That is, when a count of words (foul language words) having grades higher than a prescribed word-grade or words preset as a default exceeds a reference number during a prescribed time period, the optical disc apparatus determines a need impose viewing restrictions, and enters a playback stop mode to stop playing the disc. When a user enters a predetermined password in the playback stop mode, the optical disk apparatus resumes the playback function at the same point where playback stopped, and normally performs the playback function from that time. In more detail, when an adult user enters a correct password after previously setting up the password to activate a locking function, the locking function is unlocked to allow playback to resume.

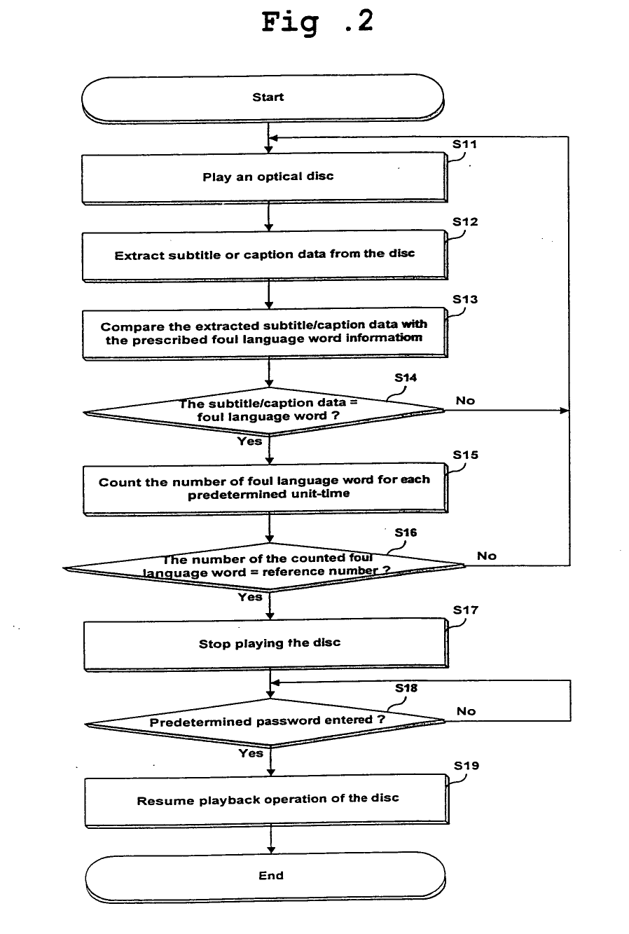

FIG. 2 is a flow chart illustrating a playback control method for the optical disc apparatus shown in FIG. 1 in accordance with the first preferred embodiment of the present invention.

It should be noted that the optical disc apparatus performing the control method shown in FIG. 2 previously stores a variety of word-grade information prescribed by a user in a database.

Referring to FIG. 2, if the user inserts an optical disc and enters a playback start command for the disc, and word-grade information has already been stored in the database, the optical disc apparatus starts a playback function of the optical disc at step S11. In more detail, the optical disc apparatus reads video data, audio data, and subtitle data or caption data that is recorded on a recording surface of the disc, performs signaling with them, and then outputs the resultant data to a display.

In this case, the optical disc apparatus extracts subtitle or caption data from the optical disc currently played at step S12, and determines whether the extracted subtitle or caption data include words (foul language words, also called unhealthy words) having a word-grade higher than a prescribed word-grade based on the word-grade information stored in the database at step S13.

It is determined at step S14 whether words from the extracted subtitle or caption data includes words (foul language words, also called unhealthy words) having a word-grade higher than the prescribed word-grade. If the extracted words do not have a word-grade higher than the prescribed word-grade, the optical disc apparatus returns to step S11 to repeatedly perform successive playback operations. If the extracted words have a word-grade higher than the prescribed word-grade, the optical disc apparatus starts to count the number of foul language word included in the extracted subtitle or caption data for a predetermined time period at step S15.

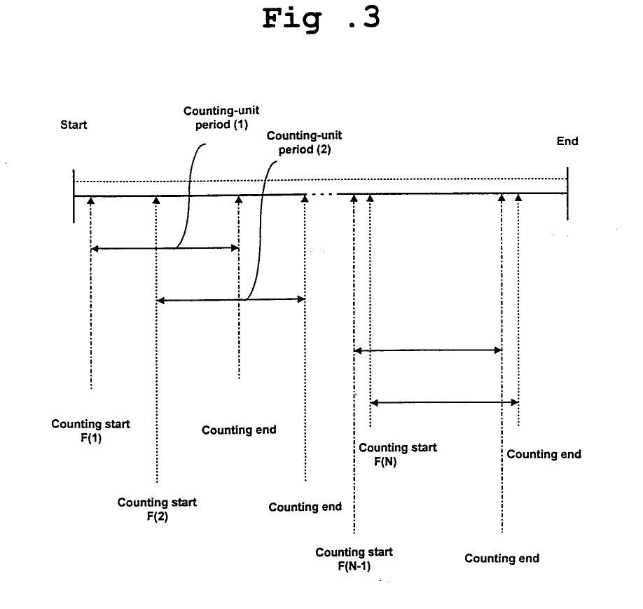

FIG. 3 is an exemplary conceptual diagram illustrating a procedure for counting any foul language words for each predetermined unit-time in accordance with a preferred embodiment of the present invention. Referring to FIG. 3, the number of foul language words is counted for a predetermined period of time (i.e., a predetermined unit-time). For example, as shown in FIG. 3, two foul language words F(1) and F(2) are detected in a first counting-unit period (1), and only the foul language word F(2) is detected in a second counting-unit period (2). A new counting period may be started each time a foul language word is encountered. Of course, there are many other ways of determining when too many foul language words have been encountered, some of which are discussed below.

Provided that the foul language word F(2) is detected, it is recognized as the second foul language word in the first counting-unit period (1), or is recognized as a first foul language word in the second counting-unit period (2). In this way, all the foul language words are accumulatively counted.

If each counting function for counting the number of foul language word is activated at step S15, it is determined at step S16 whether the number of counted foul language words is higher than a reference number for any given counting-unit period. If so, a playback operation is interrupted at step S17. If the number of counted foul language words is lower than the reference number, the program returns to step S11 to repeatedly perform successive playback operations.

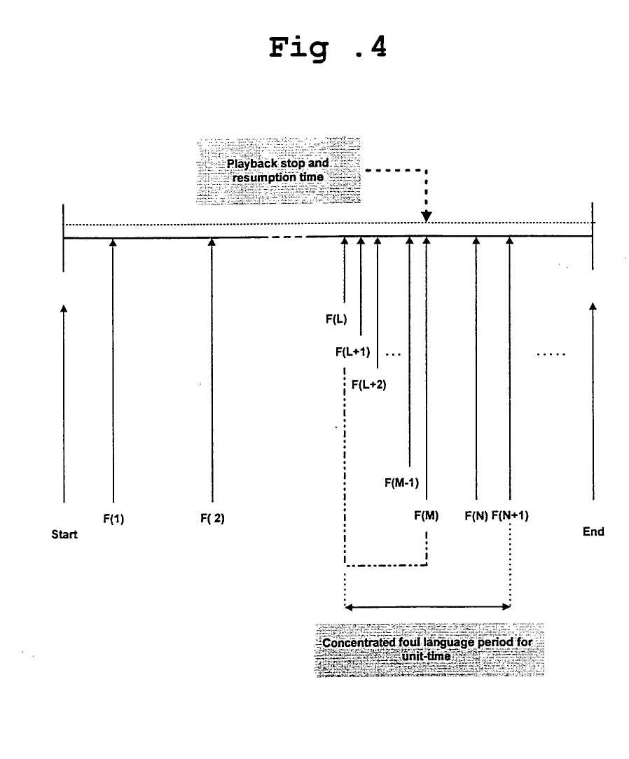

Referring to FIG. 3 in more detail, the above procedure for determining whether the number of counted foul language words is higher than the reference number at step S16 is established on the basis of the number of all the foul language words counted for the predetermined counting-unit period. As shown in FIG. 4, when the predetermined number of foul language words F(L)˜F(M) is collectively detected during a single counting-unit period, the playback operation for the disc is interrupted when the predetermined number of foul language words F(L)˜F(M) have been collectively detected, and thereby a playback stop mode is activated in step S17.

Thereafter, it is determined at step S18 whether a user enters a predetermined password in the playback stop mode. If it is determined at step S18 that the user enters the predetermined password, the playback operation for the disc resumes at the same point at which the playback stop mode was activated at step S19.

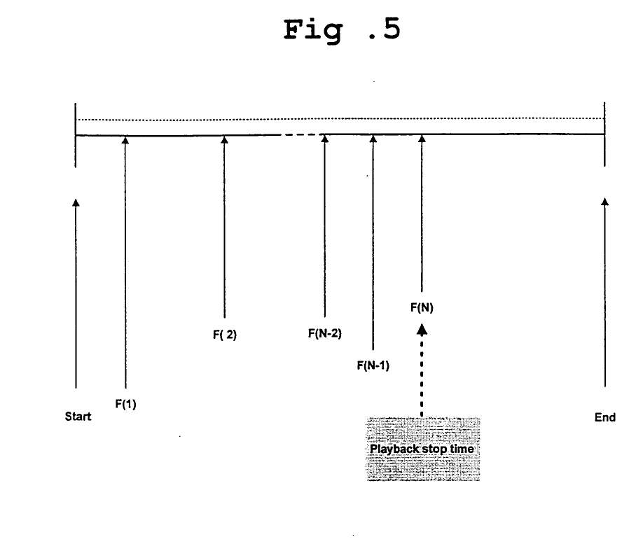

FIG. 5 is an exemplary conceptual diagram illustrating a restrictive playback operation that utilizes the total number of all foul language word detected during the playback mode in accordance with another preferred embodiment of the present invention. As shown in FIG. 5, when the total number of foul language words exceeds a reference number, the playback operation is interrupted.

As will be appreciated by those of skill in the art, other methods of counting foul language words could also be used to determine when to stop a playback operation.

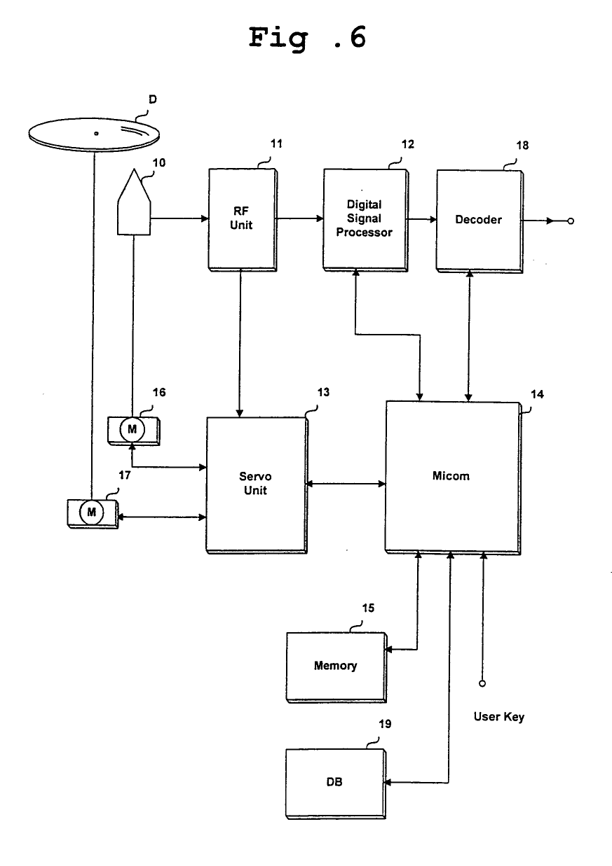

A playback control method for an optical disc apparatus according to a second preferred embodiment of the present invention will hereinafter be described with reference to FIGS. 6 to 9. This method is particularly advantageous in helping people to learn new languages using the captioning data encoded into a disc.

FIG. 6 is a view illustrating a block diagram of the optical disc apparatus utilizing the playback control method in accordance with the second preferred embodiment of the present invention. Referring to FIG. 6, the optical disc apparatus such as a DVD player includes an optical pick-up unit 10, an RF unit 11, a digital signal processor 12, a decoder 18, a microcomputer 14, a servo unit 13, a sled motor 16, a spindle motor 17, a memory 15, and a database 19.

The database 19 stores word-grade information for individual words that may appear in subtitle or caption data read from an optical disc such as a DVD disc. The word-grade information is classified into a plurality of groups based on difficulty levels of predetermined words. Each group contains more than two words that are determined to have the same difficulty level.

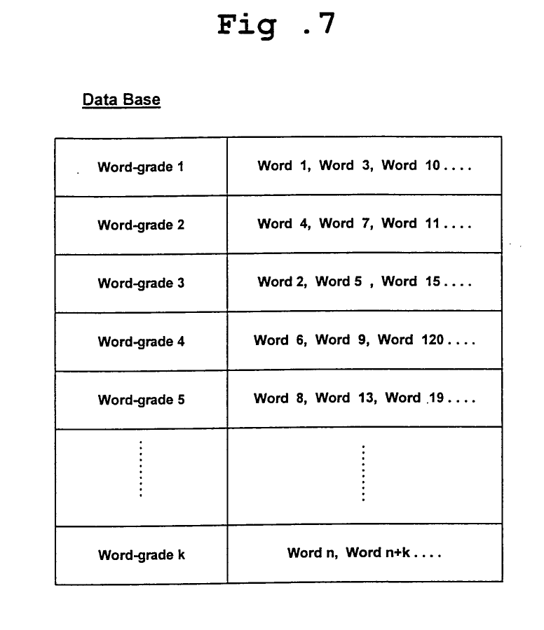

For example, as shown in FIG. 7, the database 19 stores a plurality of word-grade information ranging from 1st to K-th word-grades. A plurality of words having similar difficulty levels are collected into one group and then stored separately from another group.

The microcomputer 14 controls the individual components shown in FIG. 6 to perform a common data playback operation for reading/reproducing data recorded on the disc. If a user enters a prescribed key command, for example, a caption playback key command for every grade, the microcomputer 14 searches for and confirms grade information of individual words of subtitle or caption data retrieved from the disc in the database 19. The microcomputer then controls the playback of the audio and video information so that each sentence is repeated multiple times. The first time the sentence is displayed, simple words are presented, and difficult words are presented as blank spaces. During successive presentations of the sentence, the blanks are gradually filled in with words of increasing difficulty.

The microcomputer 14 determines the number of playback times and playback sequence of the words contained in one sentence based on the confirmed grade information for the words. Typically, the microcomputer 14 would performs successive caption playback operations for each word grade to repeatedly reproduce the words, such that words with relatively high difficulties, i.e., high-grade words, are gradually shifted from a blank-space display mode to a visible display mode.

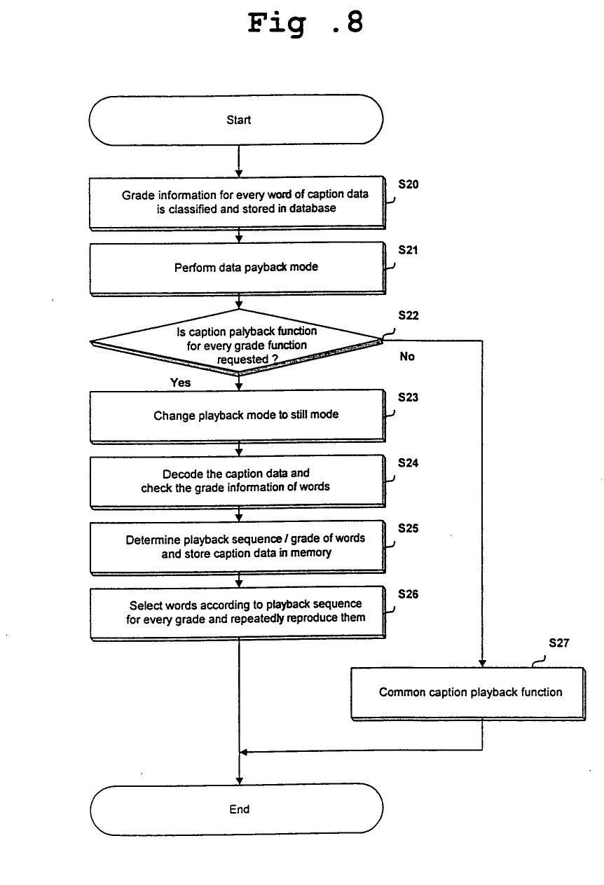

FIG. 8 is a flow chart illustrating a playback control method for the optical disc apparatus shown in FIG. 6 in accordance with the second preferred embodiment of the present invention. Referring to FIG. 8, if a user requests the optical disc apparatus to perform a data playback mode, and word-grade information for every word is stored in the database 19 at step S20, the microcomputer 14 controls the components of FIG. 6 to read/reproduce data recorded on the disc D at step S21.

If it is determined that the user has requested the optical disc apparatus to perform a caption playback function for every grade in the data playback mode at step S22, the microcomputer 14 reads subtitle or caption data recorded on the disc and changes a current playback mode to a still mode at step S23.

After decoding the read subtitle or caption data, the optical disc apparatus searches for and confirms word grades of the read subtitle or caption data on the basis of word grade information stored in the database 19 at step S24.

The microcomputer 14 determines grades of individual words, determines a playback sequence for every word according to the determined grades, and stores corresponding playback data in the memory 15.

Thereafter, the optical disc apparatus repeatedly performs a caption playback operation for every grade, such that words of relatively high grades are gradually shifted from a blank-space display mode to a visible display mode according to the determined playback sequence.

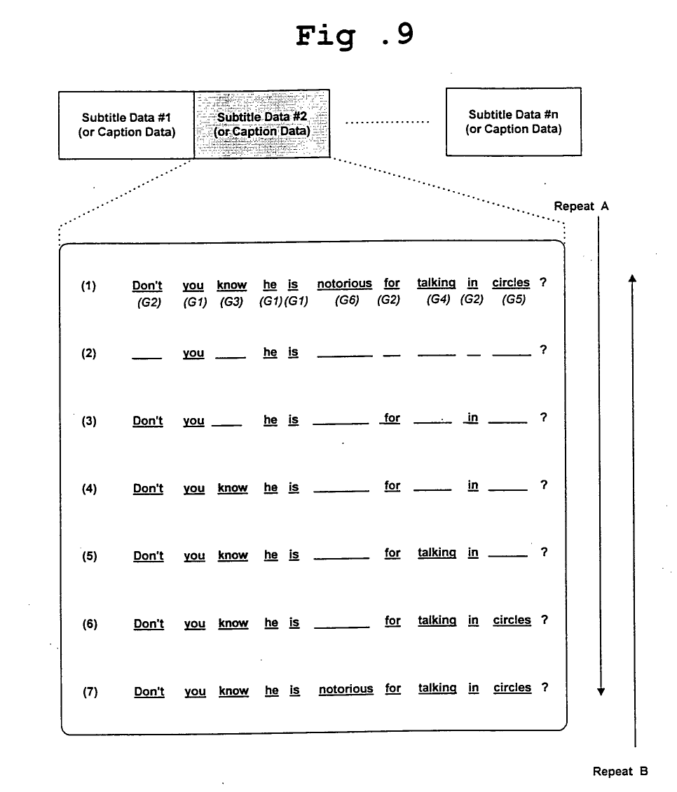

FIG. 9 shows how a single sentence of subtitle information would be displayed in this mode. In this example, the subtitle is composed of one sentence: “Don't you know he is notorious for talking in circles?” This example also assumes that the individual words contained in the sentence are assigned first to sixth word-grades G1˜G6.

A first caption playback displays all the words of the sentence without any change. A second caption playback selectively displays only words assigned the first word-grade G1, while displaying words assigned from the second to sixth word-grades G2˜G6 in the form of a blank space. Specifically, during the second playback, a partial sentence of “- - - you - - - he is - - - ?” is displayed. A third caption playback displays a partial sentence of “Don't you - - - he is - - - for - - - in - - -48 ”. A fourth caption playback displays a partial sentence of “Don't you know he is - - - for - - - in - - - ?”. In this way, words contained in one sentence are selectively reproduced according to their word-grades.

Once the whole sentence of “Don't you know he is notorious for talking in circles?” is displayed during the final caption playback, the optical disc apparatus stops the caption playback mode. The apparatus then performs a general data playback operation until the next caption data is read.

A caption playback sequence in the caption playback modes for every word-grade may be set to a Repeat-A sequence, as denoted by Repeat-A in FIG. 9, or a Repeat-B sequence, as denoted by Repeat-B in FIG. 9. In the Repeat-A sequence, caption words are repeatedly outputted in ascending numerical order of their word-grades. In the Repeat-B sequence, caption words are repeatedly outputted in descending numerical order of their word-grades.

In some embodiments of the invention, an audio playback mode may also be selectively performed along with the caption playback mode for every word-grade. Also, in some embodiments of the invention, the playback of the captioning data may not be performed for every word grade individually. For instance, the user could specify that only three repetitions be performed. In this embodiment, two or more word grades might be grouped into a single repetition of the display sequence.

As apparent from the above description, the present invention provides a method for controlling a playback function of an optical disc apparatus, which determines whether the number of words (i.e., foul language words), having a word-grade higher than a prescribed word-grade, contained in subtitle/caption data of an optical disc is higher than a reference number. The determination is made using a variety of word-grade information stored in a database. This playback mode prevents the disc from being played if the number of words having a word-grade higher than a prescribed word-grade contained in the disc is higher than the reference number, thereby preventing adolescents or children from being freely exposed to harmful programs such as an erotic video program intended only for adults.

In addition, the present invention provides a method for controlling a playback function of an optical disc apparatus, which classifies a plurality of words contained in subtitle/caption data read from an optical disc into a plurality of groups on the basis of some prescribed grades of words. This playback mode variably determines the number of playback times or playback sequences of each word, and selectively and repeatedly reproduces individual words of the subtitle/caption data. This playback mode allows a user to gradually and repeatedly view individual words contained in one sentence on the basis of word grades classified according to difficulty. This results in greater convenience for the user in learning a foreign language using a caption playback function.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for controlling a playback function of an optical disc apparatus, the optical disk apparatus having a database that indicates a word-grade for each of a plurality of words, the method comprising:
reading words from a captioning or subtitle track recorded on an optical disk as the optical disk is played;
determining a word-grade for words read from the captioning or subtitle track using the database;
counting, for a predetermined period of time, the number of words having a word-grade that exceeds a predetermined word-grade; and
determining a viewer-grade of the optical disc based on the number of words counted during a predetermined period of time that have a word-grade that exceeds the predetermined word-grade.

2. The method as set forth in claim 1, further comprising determining whether to keep playing the disc based on the determined viewer-grade.

3. The method as set forth in claim 1, further comprising setting a viewer-grade of an optical disc to be played by the optical disc apparatus.

4. The method as set forth in claim 3, further comprising stopping playing of the optical disk if the determined viewer-grade exceeds the set viewer-grade.

5. The method as set forth in claim 4, further comprising re-starting playing of the optical disk if a user inputs an acceptable password.

6. The method as set forth in claim 3, wherein the database includes word-grades having a higher value for foul language words.

7. The method as set forth in claim 6, wherein the step of setting a viewer grade allows older viewers to view optical disks containing words that have a high word-grade.

8. The method as set forth in claim 6, wherein the step of setting a viewer grade prevents younger viewers from viewing an optical disk having words with a high word-grade.

9. The method as set forth in claim 1, wherein the counting step comprises:
counting for a first predetermined period of time, the number of words having a word-grade that exceeds a predetermined word-grade; and
counting, for a second predetermined period of time, the number of words having a word-grade that exceeds a predetermined word-grade, wherein the first predetermined period of time overlaps with the second predetermined period of time.

10. A method for controlling a playback function of an optical disc apparatus, the optical disk apparatus having a database that indicates a multi-level word-grade for each of a plurality of words, the method comprising:
reading words from a captioning or subtitle track recorded on an optical disk as the optical disk is played;
determining a word-grade for words read from the captioning or subtitle track using the database;
stopping playing of the optical disk if the determined word-grade for a word read from the captioning or subtitle track exceeds a predetermined word-grade.

11. The method as set forth in claim 10, further comprising re-starting playing of the optical disk if a user inputs an acceptable password.

12. A method for controlling a playback function of an optical disc apparatus, the optical disk apparatus having a database that indicates a multi-level word-grade for each of a plurality of words, the method comprising:
reading words from a captioning or subtitle track on the optical disk as the optical disk is played;
determining a word-grade for words read from the captioning or subtitle track using the database;
incrementing a count variable each time the determined word-grade for a word read from the captioning or subtitle track exceeds a predetermined word-grade; and
stopping the playing of the optical disc if the count variable exceeds a predetermined count number.

13. The method according to claim 12, further comprising setting the predetermined word-grade before the optical disk is played.

14. The method according to claim 12, further comprising re-starting the playing of the optical disk if a user inputs an acceptable password.

15. The method according to claim 12, further comprising setting the predetermined count number before the optical disk is played.

16. A method for controlling a playback function of an optical disc apparatus, the optical disk apparatus having a database that indicates a word-grade for each of a plurality of words, the method comprising:
reading words from a caption or subtitle track from an optical disk;
determining a word-grade for the words read from the caption or subtitle track using the database; and
outputting a signal to display a portion of the caption or subtitle track, wherein one or more words in the portion are displayed in the form of a blank space based on the determined word-grades of the words in the sentence.

17. The method according to claim 16, wherein the outputting step comprises outputting a signal to display a portion of the caption or subtitle track, wherein words in the portion having a word-grade that exceed a predetermined word-grade are displayed as blank spaces.

18. The method as set forth in claim 16, wherein the outputting step comprises:
(a) outputting a signal to display a portion of the caption or subtitle track, wherein words in the portion having a word-grade that exceed a predetermined word-grade are displayed as blank spaces;
(b) increasing the predetermined word-grade by one level; and
(c) repeating steps (a) and (b) until all words in the portion are displayed.

19. The method as set forth in claim 18, wherein the outputting, increasing and repeating steps are performed in response to a comment signal provided by a user.

20. The method as set forth in claim 19, wherein the reading and determining steps are repeatedly performed as a video read from the optical disk is played, and wherein the optical disk apparatus switches to a still mode when the user provides the comment signal.

21. The method as set forth in claim 20, wherein audio playback of the displayed sentence is repeated each time the outputting step is performed.

22. The method as set forth in claim 20, wherein the optical disk apparatus automatically switches back to a play mode after the outputting, increasing and repeating steps have been performed.

23. The method as set forth in claim 16, wherein the different word-grades correspond to different difficulty levels.

24. A method for controlling a playback function of an optical disc apparatus, the optical disk apparatus having a database that indicates a word-grade for each of a plurality of words, the method comprising:
(a) reading words from a caption or subtitle track from an optical disk;
(b) determining a word-grade for the words read from the caption or subtitle track using the database; and
(c) outputting a signal to display a portion of the caption or subtitle track, wherein each of the words in the portion are displayed;
(d) outputting a signal to display the portion wherein words in the portion having a word-grade that exceeds a predetermined word-grade are displayed as blank spaces;
(e) reducing the predetermined word-grade by one level; and
(f) repeating steps (d) and (e) until only words having the lowest word-grade are displayed.

25. The method as set forth in claim 24, wherein the different word-grades correspond to different difficulty levels.
